(19) United States
(12) Patent Application Publication
(10) Pub. No.: US 2024/0242198 A1
(43) Pub. Date: Jul. 18, 2024

(54) DUAL USE DIGITAL GIFT CARD

(71) Applicant: Scott C. Nevins, Riverside, CT (US)

(72) Inventor: Scott C. Nevins, Riverside, CT (US)

(21) Appl. No.: 18/403,647

(22) Filed: Jan. 3, 2024

Related U.S. Application Data
(60) Provisional application No. 63/479,749, filed on Jan. 13, 2023.

(51) Int. Cl. G06Q 20/34; G06Q 20/10; G06Q 20/28; G06Q 20/36

(52) U.S. Cl. CPC G06Q 20/342; G06Q 20/105; G06Q 20/28; G06Q 20/351; G06Q 20/36

(57) ABSTRACT

A dual use digital gift card defines a first prepaid amount designated for at least one benefactor-selected first designated entity of a first entity type, and a second prepaid amount designated for payment of transactions in exchange for goods or services at a second entity type different from the first entity type. A balance access rule restricts access to the second prepaid amount based on a balance of the first prepaid amount. The dual use digital gift card is generated with a unique card reference and stored within memory of a server. The unique card reference is sent to the benefactor and may be sent to a beneficiary. The beneficiary uses the dual use digital gift card to transact the first prepaid amount to the at least one benefactor-selected first entity prior to using the second prepaid amount for the goods or services at the second entity type.

### RELATED APPLICATION

This application claim priority to U.S. Patent Application No. 63/479,749, titled “Dual Use Digital Gift Card,” filed Jan. 13, 2023, which is incorporated herein in its entirety by reference.

### BACKGROUND

Payment devices having stored and/or prepaid values in the form of a balance, such as physical gift cards, are commonly utilized for performing in-person financial transactions. Such devices are also commonly provided as gifts between individuals, and has a prepaid balance for a designated entity, such as a store or restaurant, or a prepaid balance for use at any entity. A recipient of the gift card can only use the balance in one or more transactions with the designated entity, to purchase goods or services.

### SUMMARY

In certain embodiments, a dual use digital gift card method includes receiving, at a server and from a benefactor, a request to create a dual use digital gift card, the request including: a first prepaid amount; at least one benefactor-selected first designated entity of a first entity type, the first prepaid amount being designated for transfer to the at least one benefactor-selected first designated entity; a second prepaid amount being designated for payment of transactions in exchange for goods or services at a second entity type different from the first entity type; and a balance access rule that restricts access to the second prepaid amount based on a balance of the first prepaid amount. The method further includes receiving, from the benefactor, a payment transaction having a transaction value at least equal to a sum of the first prepaid amount and the second prepaid amount; generating, within memory of the server, the dual use digital gift card having a unique card reference, the first prepaid amount, the at least one benefactor-selected first designated entity, the second prepaid amount, and the balance access rule; and sending the unique card reference to the benefactor.

In certain embodiments, a dual use digital gift card method includes: receiving, at a client device, a unique card reference for a dual use digital gift card; storing the unique card reference in a digital wallet of the client device; displaying, on a screen of the client device when the dual use digital gift card is accessed in the digital wallet, an interactive interface defining: a first prepaid amount associated with the dual use digital gift card; a first list of benefactor-selected first entities of a first entity type; and a second prepaid amount designated for payment of transactions to one or more benefactor-selected second entities of a second entity type, different from the first entity type. The method further includes receiving a selected first entity from the first list of first entities; and initiating a transaction to the selected first entity for the first prepaid amount.

In certain embodiments, a dual use digital gift card method includes receiving, at a server and from a benefactor, a request to create a dual use digital gift card, the request including: a first prepaid amount; one first designated entity of a first entity type; a second prepaid amount; and at least one second designated entity of a second entity type, different from the first entity type, the second prepaid amount being designated for payment of transactions to one or more of the at least one second designated entity. The method further includes receiving, from the benefactor, a payment transaction having a transaction value at least equal to a sum of the first prepaid amount and the second prepaid amount; generating, within memory of the server, the dual use digital gift card having a unique card reference, the first prepaid amount, the one first designated entity, the second prepaid amount, and the at least one second designated entity; initiating a transaction to the one first designated entity for the first prepaid amount; and sending the unique card reference to the benefactor.

### BRIEF DESCRIPTION OF THE FIGURES

FIG. 1 is a schematic illustrating one example dual use digital gift card system, in embodiments.

FIG. 2 is a block diagram illustrating issuer/server of FIG. 1 in further example detail, in embodiments.

FIG. 3A-D show example interactive interfaces that may be displayed on client device, in embodiments.

FIG. 4 is a flowchart illustrating one example dual use digital gift card method, in embodiments.

FIG. 5 is a flowchart illustrating one example dual use digital gift card method for interacting with a beneficiary of ecard, in embodiments.

### DETAILED DESCRIPTION OF THE EMBODIMENTS

U.S. Pat. No. 10,825,019, incorporated herein by reference, discloses a single pre-funded electronic payment device having dual configurable payment mechanisms. While such physical devices (e.g., a physical gift card) fill a certain need, physical shipping and handling of the card is required to transfer ownership to a second party and to use the prepaid balances on the card.

A digital gift card increases versatility by permitting delivery of the digital gift card via electronic means, such as email or text or other types of messaging. However, existing implementation of the digital gift card only allow for a single prepaid amount and a single designated entity to receive transactions therefrom. Thus, a benefactor wishing to designate a portion of the digital gift card to a selectable charity has no control of whether the beneficiary does so. The present embodiments solve this problem by implementing a dual use digital gift card that allows the benefactor to define a primary entity (e.g., a charity) for the digital gift card to receive a first prepaid amount prior to the beneficiary using a second prepaid amount at a secondary entity (e.g., a merchant). The embodiments below describe example methods and services for providing a dual use digital gift card that has a first prepaid amount designated for at least one first entity (e.g., one or more charity organizations) and a second prepaid amount designated for at least one second entity (e.g., a retail store or service). The digital gift card may be sent (e.g., via email, text, messaging, social network, etc.) to a beneficiary who may select one of the at least one first entity to receive the first prepaid amount (or may select multiple ones of the at least one first entities to each receive a portion of the first prepaid amount) and may then perform one or more transactions with one of the at least one second entity (or may make multiple transactions up to the limit of the second prepaid amount). The benefactor may set an expiration date, after which any remaining balance (e.g., remaining first prepaid amount and/or remaining second prepaid amount) is transacted to a first or primary of the at least one first entity. In certain embodiments, where only one entity is listed in the at least one first entity (e.g., a required beneficiary of the first prepaid amount), a transaction for the first prepaid amount to the one entity may occur automatically (e.g., without requiring the beneficiary to initiate the transaction) when the digital gift card is created by the benefactor. Thus, the designated entity does not need to wait for the beneficiary to make the transaction to receive the donation. Further, where the beneficiary does not exhaust the first and/or second prepaid amount on the digital gift card prior to the expiration date, any remaining funds are automatically transacted to the first beneficiary, thus the funds are not lost, even when the digital gift card is lost or forgotten.

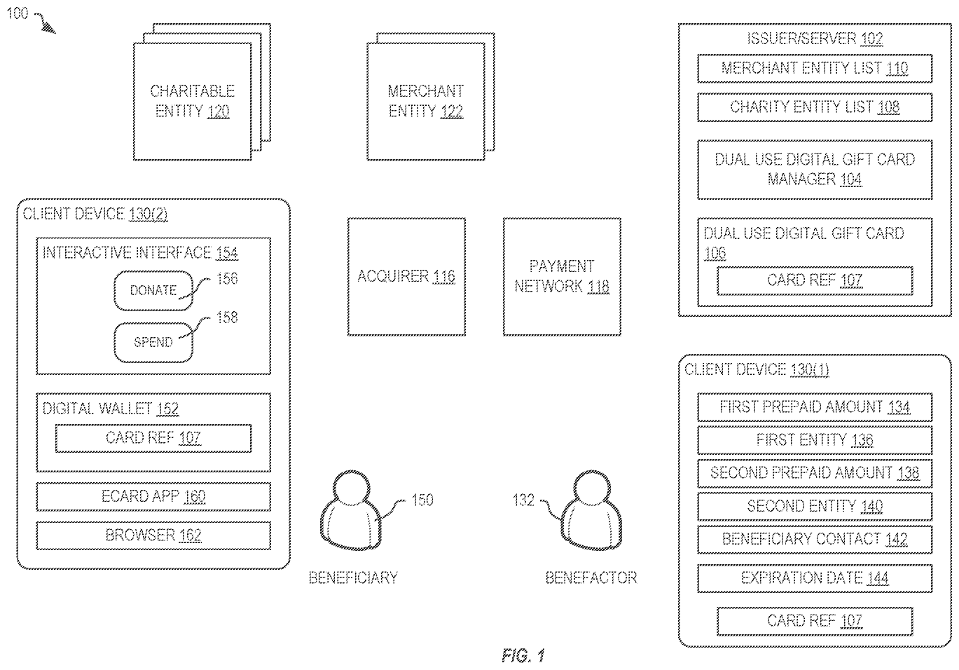

FIG. 1 is a schematic illustrating one example dual use digital gift card system 100. System 100 includes an issuer/server 102, an acquirer 116, and a payment network 118. Issuer/server 102, acquirer 116, and payment network 118 include functionality for implementing financial transactions, and well known in the art. However, issuer/server 102 further includes a dual use digital gift card manager 104 that implements functionality for managing and transacting a dual use digital gift card 106 (herein after ecard 106). In the example of FIG. 1, a benefactor 132 wishes to create and send ecard 106 to a beneficiary 150, designating a portion of the total funds for a charitable entity 120, and the remaining portion of the total fund for user at a merchant entity 122.

In certain embodiments, benefactor 132 uses a client device 130(1) to interact with manager 104 and define ecard 106. In other embodiments, benefactor 132 uses a client device 130(1) to interact with a separate computer server to define ecard 106, wherein the separate computer server interacts (e.g., via API calls) with issuer/server 102 to create ecard 106. Benefactor 132 uses a client device 130(1) to define a first prepaid amount 134, a first entity 136, a second prepaid amount 138, and a second entity 140, and a beneficiary contact 142 (e.g., an email address, a phone number, etc.). First prepaid amount 134 and second prepaid amount 138 each may be in any currency (e.g., US Dollar, Sterling, crypto-currencies, etc.). In one example of operation, manager 104 provides client device 130(1) with a charity entity list 108 that lists a plurality of charitable entities 120 that are registered with issuer/server 102 and a merchant entity list 110 at lists a plurality of merchant entities 122 that are registered with issuer/server 102. Benefactor 132 may then select one charitable entity 120, or more, from charity entity list 108 as first entity 136. That is, benefactor-selected first entity 136 may be a single charitable entity 120, or benefactor-selected first entity 136 may be a list of two or more charitable entities 120 selected by benefactor 132. Benefactor-selected second entity 140 is one or more of merchant entity 122. In certain embodiments, first entity 136 and second entity 140 are branded.

Manager 104 may also receive a financial transaction from client device 130(1) corresponding to a sum of first prepaid amount 134 and second prepaid amount 138, such that ecard 106 is prepaid by benefactor 132. Manager 104 generates ecard 106 based on the received information and funds and assigns a unique card reference 107. In certain embodiments, where ecard 106 has an associated cost or fee applied by issuer/server 102, this cost/fee may be added to the financial transaction, such that benefactor 132 pays the cost/fee. In other embodiments, the associated cost or fee applied by issuer/server 102 is taken from one of first prepaid amount 134 and second prepaid amount 138.

In certain embodiments, benefactor 132 defines an expiration date 144 (e.g., one month, six months, one year, etc.) that is associated and included with ecard 106. Expiration date 144 defines a future date by when beneficiary 150 is expected to use the funds on ecard 106.

Once ecard 106 is created, issuer/server 102 may send card reference 107 to client device 130(1) of benefactor 132. In certain embodiments, card reference 107 is a URL with an embedded unique reference to ecard 106. Benefactor 132 may then send card reference 107 to beneficiary with a personal message. In certain embodiments, issuer/server 102 sends card reference 107 to client device 130(2) of beneficiary 150 based on beneficiary contact 142 provided by benefactor 132. In certain embodiments, beneficiary 150 may store unique card reference 107 in a digital wallet 152 of client device 130(2).

In certain embodiments, manager 104 generates an interactive interface 154 (e.g., a web interface, a web page, and/or web site) that displays ecard 106. In other embodiments, interactive interface 154 is generated external to issuer/server 102, such as within a separate computer server that may be networked (e.g., via the Internet) with issuer/server 102. Interactive interface 154 may include a donate button 156 that allows beneficiary 150 to send first prepaid amount 134 to a selected first entity 136 and a spend button 158 that allows beneficiary 150 to send funds, via acquirer 116 and payment network 118 for example, from second prepaid amount 138 to a merchant entity 122 selected from second entity 140.

Where first entity 136 includes two or more charitable entities 120, a beneficiary of ecard 106 may select one or more of them to receive first prepaid amount 134. Where first entity 136 includes only one charitable entity 120, first prepaid amount 134 may be sent to the selected charitable entity 120 at the creation of ecard 106. That is, the selected charitable entity 120 need not wait for the recipient to activate ecard 106 and make the donation but may receive the donation soon after ecard 106 is created. Alternatively, ecard 106 may be configures such that beneficiary 150 selects a donate button 156 to cause first prepaid amount 134 to be sent to the selected charitable entity 120.

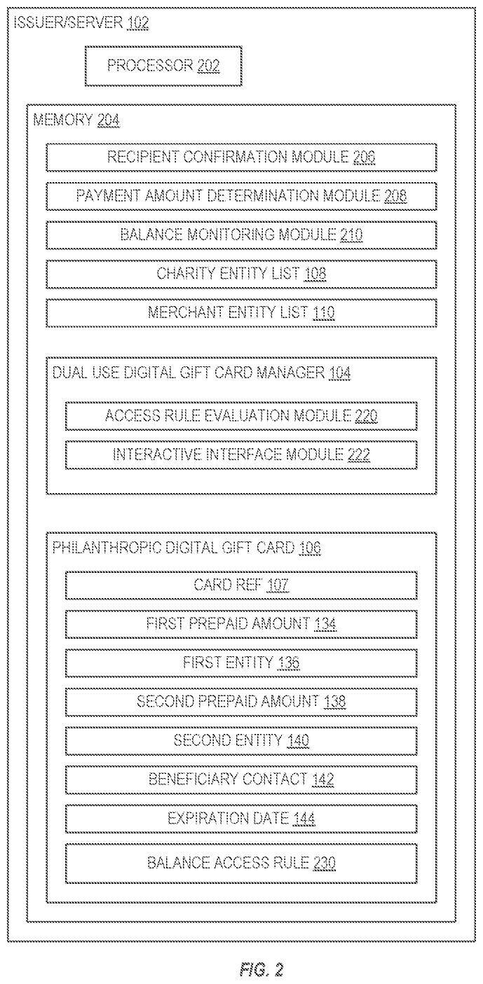

FIG. 2 is a block diagram illustrating issuer/server 102 of FIG. 1 in further example detail. As described above, issuer/server 102 may operate similarly to a card issuer, known in the art, and includes at least one processor 202 communicatively coupled with memory 204 that stores machine-readable instructions, executable by processor 202, to implement a recipient confirmation module 206, a payment amount determination module 208, and a balance monitoring module 210.

Issuer/server 102 further includes dual use digital gift card manager 104, stored in memory 204 with machine-readable instruction that, when executed by processor 202, cause issuer/server 102 to create and facilitate use of ecard 106. Manager 104 limits transactions for from first prepaid amount 134 to first entity 136. That is, manager 104 only allows funds from first prepaid amount 134 to be paid to one or more entities listed by first entity 136. Similarly, manager 104 limits transactions for from second prepaid amount 138 to second entity 140. That is, manager 104 only allows funds from second prepaid amount 138 to be paid to one or more of entities listed by second entity 140. An entity type of second entity 140 may be different from an entity type of first entity 136. For example, first entity 136 may be a charitable entity (e.g., charitable entity 120) and second entity 140 may be a merchant (e.g., merchant entity 122).

Dual use digital gift card manager 104 includes an access rule evaluation module 220 that restricts use of second prepaid amount 138 until first prepaid amount 134 is zero, or below a predefined threshold (e.g., ten cents). In certain embodiments, ecard 106 includes a second balance access rule 230 that includes a logic statement, logic rules, and/or formulae (e.g., first balance=zero, or first balance<=0.1 or other predefined amount) that define requirements for beneficiary 150 to access and use second prepaid amount 138. For example, access rule evaluation module 220 inhibits beneficiary 150 from selecting spend button 158 until second balance access rule 230 becomes true indicating that a remaining balance of first prepaid amount 134 is zero. That is, second prepaid amount 138 is not usable until second balance access rule 230 is satisfied. In one example of operation, second balance access rule 230 is selected and/or defined by benefactor 132 when creating ecard 106. In other embodiments, second balance access rule 230 is predefined to require first prepaid amount 134 to be zero. In yet other embodiments, second balance access rule 230 is omitted, or null, and use of first prepaid amount 134 and second prepaid amount 138 is unrestricted.

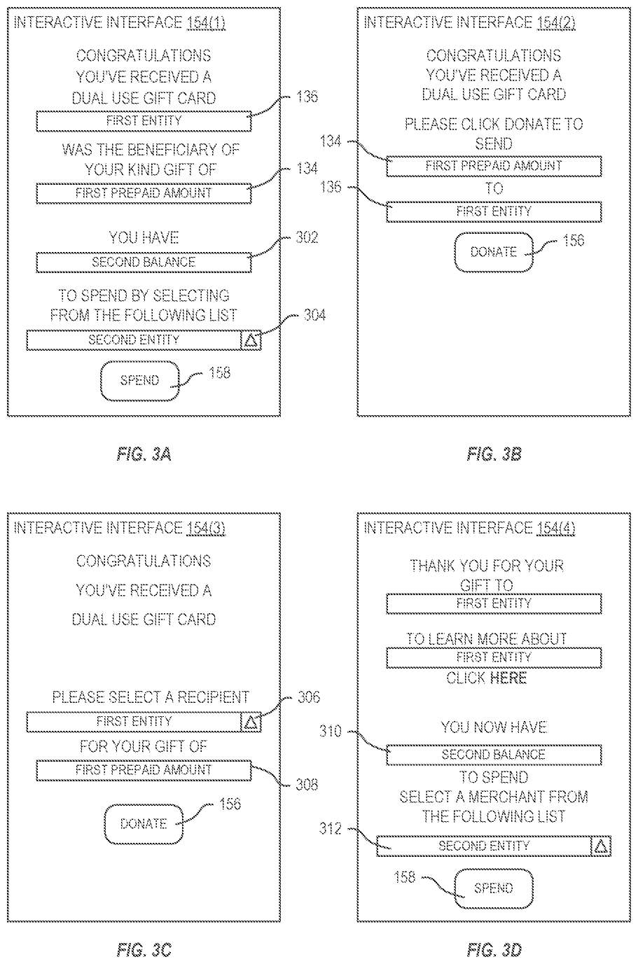

Dual use digital gift card manager 104 may also include an interactive interface module 222 that interacts with beneficiary 150 via client device 130(2) and one or more interactive interfaces 154 (see FIGS. 3A-3D). In certain embodiments, interactive interface module 222 may implement a web interface, a web page, and/or web site for interacting with client device 130(2). For example, beneficiary 150 may use a browser 162 of client device 130(2) to interact with interactive interface module 222.

In certain embodiments, beneficiary 150 downloads an ecard app 160 to client device 130(2) whereby interactive interface module 222 cooperates with ecard app 160 to display interactive interface 154. For example, ecard app 160 is created to specifically interact with issuer/server 102 and facilitate use of ecard 106.

FIG. 3A shows a first example interactive interface 154(1) that may be displayed on client device 130(2) to beneficiary 150 upon delivery of ecard 106 when first prepaid amount 134 has already been paid to first entity. As shown, interactive interface 154(1) includes messages indicating that beneficiary has already donated a gift of first prepaid amount 134 to the indicated first entity 136. Interactive interface 154(1) may further display a second balance 302 that represents a remaining balance of second prepaid amount 138, a second entity pulldown list 304 and spend button 158. Beneficiary 150 may select a merchant entity 122 from second entity pulldown list 304 and then select spend button 158 to initiate or fulfill a transaction with the selected merchant entity 122. This may be repeated until second balance 302 is zero.

FIG. 3B shows a second example interactive interface 154(2) that may be displayed on client device 130(2) to beneficiary 150 upon delivery of ecard 106. In this example, even though first entity 136 only includes a single charitable entity 120, ecard 106 is configured such that beneficiary 150 selects donate button 156 to cause first prepaid amount 134 to be sent to charitable entity 120 indicated by first entity 136. Advantageously, this may allow beneficiary 150 to feel like they have donated the funds to the charitable entity 120. Further, ecard 106 may provide a learning tool, whereby benefactor 132 is teaching beneficiary 150 the benefits and satisfaction of philanthropy.

FIG. 3C shows a third example interactive interface 154(3) that may be displayed on client device 130(2) to beneficiary 150 upon delivery of ecard 106. In this example, first entity 136 includes multiple charitable entities 120, and interactive interface 154(3) displays a first pulldown list 306 that allows beneficiary 150 to select which of the listed entities should receive funds from first prepaid amount 134. First balance 308 may display remaining balance of first prepaid amount 134, whereby selecting donate button 156 causes that balance to be sent to the selected charitable entity 120. In certain embodiments, beneficiary 150 may change first balance 308 to be less than remaining first prepaid amount 134, whereby the selected charitable entity 120 receives the designated amount from first prepaid amount 134, and then first balance 308 is updated to show the remaining balance from first prepaid amount 134. Beneficiary 150 may then select another (or the same) entity from pulldown list 306 wherein selecting donate causes the first prepaid amount to be sent to the selected charitable entity 120.

FIG. 3D shows a fourth example interactive interface 154(4) that may be displayed on client device 130(2) to beneficiary 150 when first prepaid amount 134 is zero. For example, interactive interface 154(4) displays an acknowledgement that first prepaid amount 134 has been paid to first entity 136. Interactive interface 154(4) may inform beneficiary 150 of the charitable donation and may provide a link whereby beneficiary 150 may learn more about the selected charitable entity 120. Interactive interface 154(4) further displays a second balance 310 that indicate the remaining balance of second prepaid amount 138, which is available to beneficiary 150 to spend and one or mode designated merchant entities 122. Beneficiary 150 may use a pulldown list 312 to select one merchant entity 122 from second entity 140, and then select spend button 158 to initiate a financial transaction.

Pulldown lists 304, 306, and 312 of FIGS. 3A, 3C, and 3D, may be implemented in other ways to allow beneficiary 150 to select from a list. In certain embodiments, where the number of entities in the list is small (e.g., between two and four), pull down lists 304, 306, and 312 may be implemented as a list with check boxes that may be selected by beneficiary 150. In these embodiments, where beneficiary 150 selects multiple entities, first prepaid amount 134 may be divided between the selected entities.

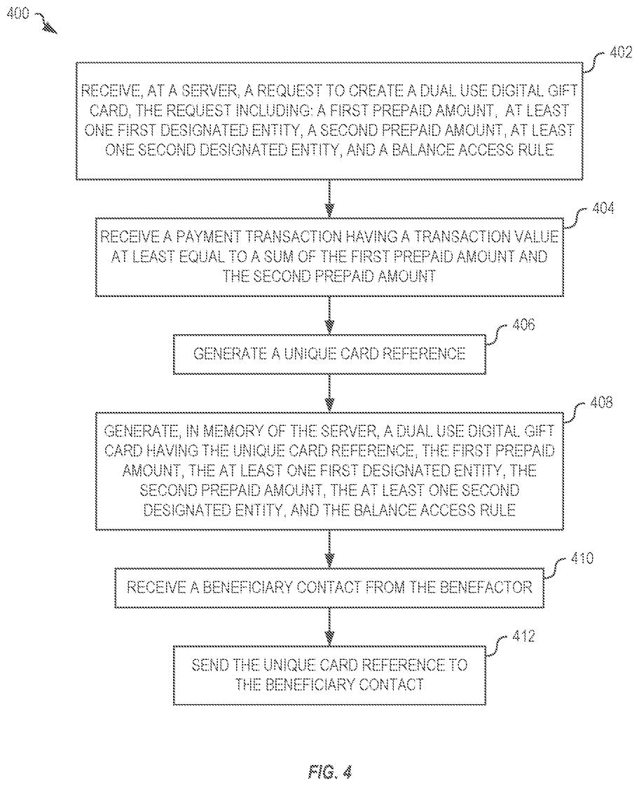

FIG. 4 is a flowchart illustrating one example dual use digital gift card method 400. Method 400 is implemented, at least in part, by dual use digital gift card manager 104 for example.

In block 402, method 400 receives, at a server, a request to create a dual use digital gift card, the request including: a first prepaid amount, at least one first designated entity, a second prepaid amount, at least one second designated entity, and a balance access rule. In one example of block 402, manager 104 receives a request to create ecard 106 from benefactor 132 via client device 130(1), the request defining first prepaid amount 134, first entity 136, second prepaid amount 138, second entity 140, and second balance access rule 230.

In block 404, method 400 receives a payment transaction having a transaction value at least equal to a sum of the first prepaid amount and the second prepaid amount. In one example of block 404, manager 104 receives a transaction from client device 130(1) with a total value equal to a sum of first prepaid amount 134 and second prepaid amount 138.

In block 406, method 400 generates a unique card reference. In one example of block 406, manager 104 generates card reference 107 to be unique to ecard 106.

In block 408, method 400 generates, in memory of the server, a dual use digital gift card having the unique card reference, the first prepaid amount, the at least one first designated entity, the second prepaid amount, the at least one second designated entity, and a balance access rule. In one example of block 408, manager 104 generates and stores ecard 106 in memory 204 of issuer/server 102, where ecard 106 includes card reference 107, first prepaid amount 134, first entity 136 corresponding to charitable entity 120, second prepaid amount 138, second entity 140 corresponding to merchant entity 122, and second balance access rule 230.

In block 410, method 400 receives a beneficiary contact from the benefactor. In one example of block 410, manager 104 receives beneficiary contact 142 from benefactor 132 via client device 130(1).

In block 412, method 400 sends the unique card reference to the beneficiary contact. In one example of block 412, manager 104 sends card reference 107 to client device 130(2) based on beneficiary contact 142.

Method 400 may have additional or fewer blocks, and the order of blocks may change without departing from the scope hereof. For example, method 400 may use one or more security techniques and protocols for communication between issuer/server 102 and client devices 130.

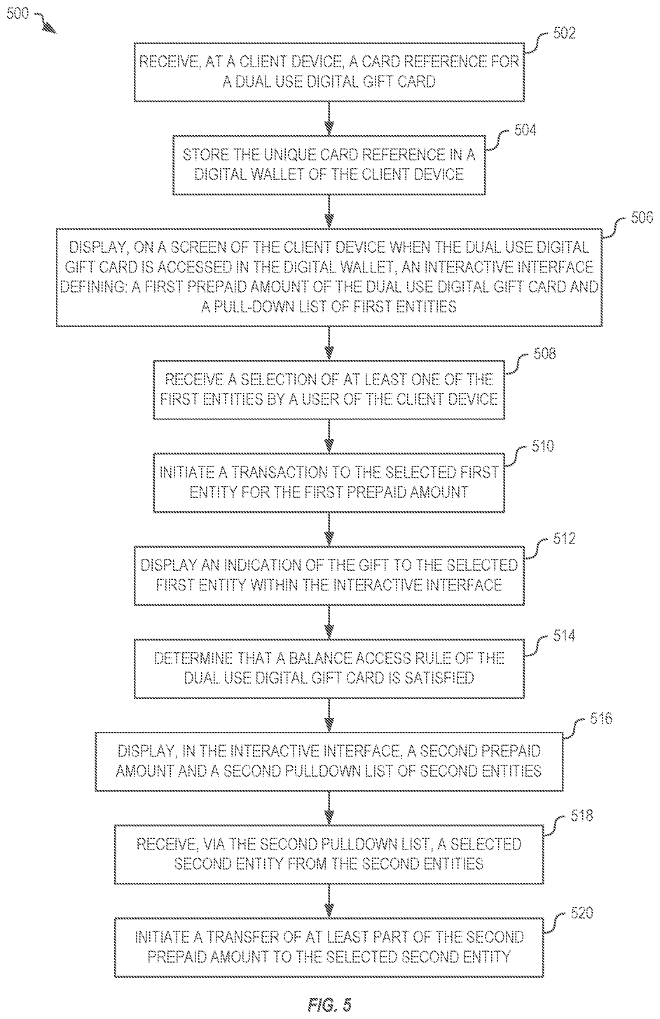

FIG. 5 is a flowchart illustrating one example dual use digital gift card method 500 for interacting with a beneficiary of ecard 106. Method 500 is implemented, at least in part, by dual use digital gift card manager 104 for example.

In block 502, method 500 receives, at a client device, a card reference for a dual use digital gift card. In one example of block 502, client device 130(2) receives card reference 107. In block 504, method 500 stores the unique card reference in a digital wallet of the client device. In one example of block 504, beneficiary 150 controls client device 130(2) to store card reference 107 in digital wallet 152.

In block 506, method 500 displays, on a screen of the client device when the dual use digital gift card is accessed in the digital wallet, an interactive interface defining: a first balance of the dual use digital gift card and a pull-down list of first entities. In one example of block 506, client device 130(2) interacts with manager 104 to receive and display interactive interface 154 when card reference 107 is selected within digital wallet 152, where interactive interface 154 includes first prepaid amount 134 and first entity 136 in pulldown list 306.

In block 508, method 500 receives a selection of at least one of the first entities by a user of the client device. In one example of block 508, manager 104 receives selection of charitable entity 120 by beneficiary 150 interacting with pulldown list 306. In block 510, method 500 initiates a transaction to the selected first entity for the first balance. In one example of block 510, manager 104 initiates a transaction to send funds from first prepaid amount 134 to charitable entity 120.

In block 512, method 500 displays an indication of the gift to the selected first entity within the interactive interface. In one example of block 512, manager 104 outputs interactive interface 154(4) to the display of client device 130(2). In block 514, method 500 determines that a balance access rule of the dual use digital gift card is satisfied. In one example of block 514, manager 104 invokes access rule evaluation module 220 to determine whether second balance access rule 230 is satisfied. In block 516, method 500 displays, in the interactive interface, a second prepaid amount and a second pulldown list of second entities. In one example of block 516, when second balance access rule 230 is satisfied, manager 104 updates interactive interface 154 to show second balance 310 corresponding to remaining funds within second prepaid amount 138 and a pulldown list 312 listing second entity 140.

In block 518, method 500 receives, via the second pulldown list, a selected second entity from the second entities. In one example of block 518, manager 104 receives selection of merchant entity 122 by beneficiary 150 interacting with pulldown list 312. In block 520, method 500 initiates a transfer of at least part of the second prepaid amount to the selected second entity. In one example of block 520, manager 104 initiates a transaction to send funds from second prepaid amount 138 to merchant entity 122.

Method 500 may have additional or fewer blocks, and the order of blocks may change without departing from the scope hereof. For example, method 500 may use one or more security techniques and protocols for communication between issuer/server 102 and client device 130(2).

In alternate embodiments, functionality of ecard 106 may be implemented as a physical card, similar to the physical gift card of U.S. Pat. No. 10,825,019, but further incorporating the additional versatility and functionality of ecard 106. For example, benefactor 132 may purchase and/or receive a physical gift card that implements functionality of ecard 106, having at least two prepaid amounts 134 and 138, at least one first entity 136, at least one second entity 140, and a second balance access rule 230. Benefactor 132 gives/sends the physical gift card to beneficiary 150. In one example of operation, beneficiary 150 interacts with issuer/server 102 to donate first prepaid amount 134 to a selected first entity 136 and thereby gain access to second prepaid amount 138. In another example of operation, when using the physical gift card for a first time at a point-of-sale (POS) terminal, beneficiary 150 may be asked to select one of first entity 136 in order to unlock second prepaid amount 138 for use in payment at the POS terminal in exchange for goods or services. In this example, the POS terminal may be configured to automatically select a particular entity (e.g., merchant entity 122 in which it is located) from second entity 140. Where the particular entity is not listed by second entity 140, the transaction is declined since the physical gift card is not intended for use at that merchant entity.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A dual use digital gift card method, comprising:
receiving, at a server and from a benefactor, a request to create a dual use digital gift card, the request including:
a first prepaid amount;
at least one benefactor-selected first designated entity of a first entity type, the first prepaid amount being designated for transfer to the at least one benefactor-selected first designated entity;
a second prepaid amount being designated for payment of transactions in exchange for goods or services at a second entity type different from the first entity type; and
a balance access rule that restricts access to the second prepaid amount based on a balance of the first prepaid amount;
receiving, from the benefactor, a payment transaction having a transaction value at least equal to a sum of the first prepaid amount and the second prepaid amount;
generating, within memory of the server, the dual use digital gift card having a unique card reference, the first prepaid amount, the at least one benefactor-selected first designated entity, the second prepaid amount, and the balance access rule; and
sending the unique card reference to the benefactor.

2. The dual use digital gift card method of claim 1, further comprising, receiving at least one benefactor-selected second entity of the second entity type designated for receiving payment of transactions from the second prepaid amount.

3. The dual use digital gift card method of claim 1, the balance access rule being a logic statement on the first prepaid amount.

4. The dual use digital gift card method of claim 1, the balance access rule being one of: requiring the first prepaid amount to be zero, and requiring the first prepaid amount to be below a predefined amount.

5. The dual use digital gift card method of claim 1, further comprising:
determining that the at least one first designated entity is a single entity; and
initiating a transaction to the at least one first designated entity for the first prepaid amount.

6. The dual use digital gift card method of claim 5, further comprising updating the first prepaid amount based on an amount of the transaction.

7. The dual use digital gift card method of claim 1, the first entity type being a charitable entity and the second entity type being a merchant entity.

8. The dual use digital gift card method of claim 1, the transaction value of the payment transaction further including a cost/fee for the dual use digital gift card.

9. A dual use digital gift card method, comprising:
receiving, at a client device, a unique card reference for a dual use digital gift card;
storing the unique card reference in a digital wallet of the client device;
displaying, on a screen of the client device when the dual use digital gift card is accessed in the digital wallet, an interactive interface defining:
a first prepaid amount associated with the dual use digital gift card;
a first list of benefactor-selected first entities of a first entity type; and
a second prepaid amount designated for payment of transactions to one or more benefactor-selected second entities of a second entity type, different from the first entity type;
receiving a selected first entity from the first list of first entities; and
initiating a transaction to the selected first entity for the first prepaid amount.

10. The dual use digital gift card method of claim 9, further comprising displaying an acknowledgement of the first prepaid amount being paid to the selected first entity within the interactive interface.

11. The dual use digital gift card method of claim 9, further comprising:
determining a balance access rule of the dual use digital gift card is satisfied, and then:
receiving a selected second entity from the second entities; and
initiating a transfer of at least part of the second prepaid amount to the selected second entity.

12. The dual use digital gift card method of claim 9, wherein balance access rule is satisfied when the first prepaid amount is zero.

13. The dual use digital gift card method of claim 9, wherein balance access rule satisfied when the first prepaid amount is less than a predefined amount.

14. The dual use digital gift card method of claim 9, wherein the second prepaid amount is not usable until a balance access rule of the dual use digital gift card is satisfied.

15. A dual use digital gift card method, comprising:
receiving, at a server and from a benefactor, a request to create a dual use digital gift card, the request including:
a first prepaid amount;
one first designated entity of a first entity type;
a second prepaid amount; and
at least one second designated entity of a second entity type, different from the first entity type, the second prepaid amount being designated for payment of transactions to one or more of the at least one second designated entity;
receiving, from the benefactor, a payment transaction having a transaction value at least equal to a sum of the first prepaid amount and the second prepaid amount;
generating, within memory of the server, the dual use digital gift card having a unique card reference, the first prepaid amount, the one first designated entity, the second prepaid amount, and the at least one second designated entity;
initiating a transaction to the one first designated entity for the first prepaid amount; and
sending the unique card reference to the benefactor.
